(19) United States
(12) Patent Application Publication
(10) Pub. No.: US 2025/0328354 A1
(43) Pub. Date: Oct. 23, 2025

(54) TECHNIQUES FOR ENUMERATION OF A SHARED MEMORY DEVICE

(71) Applicant: Intel Corporation, Santa Clara, CA (US)

(72) Inventors: Akhilesh S. THYAGATURU, Ruskin, FL (US); Jason M. HOWARD, Portland, OR (US); Gurpreet Singh KALSI, Portland, OR (US); Karthik KUMAR, Chandler, AZ (US)

(21) Appl. No.: 19/254,734

(22) Filed: Jun. 30, 2025

(51) Int. Cl. G06F 9/4401

(52) U.S. Cl. CPC G06F 9/4411; G06F 9/4406

(57) ABSTRACT

Examples include techniques associated with enumeration of a shared memory device. Examples include the shared memory device is an externally-attached shared memory device configured to maintain one or more shared memory regions that can be shared between multiple host computing platforms. The externally-attached shared memory device can communicate with a host computing platform's basic input/output operating system (BIOS) to provide device capabilities to facilitate enumeration of the externally-attached shared memory device.

### BACKGROUND

A data center may include one or more computing platforms each comprising at least one processor and associated memory modules. Each computing platform of the datacenter may facilitate the performance of any suitable number of processes associated with various applications running on and/or hosted by computing platform. These processes may be performed by the processors and other associated logic of the computing platforms. Each computing platform may additionally include I/O controllers, such as network adapter devices, which may be used to send and receive data on a network for use by the various applications.

In some examples, an externally-attached shared memory device (ESMD) can be used for low-latency, external inter-process communication (IPC) between computing platforms. With memory sharing via an ESMD, external IPC between computing platforms can be possible at high bit rates. External IPC at high bit rates can be possible because memory sharing can involve read and write operations in a same memory region of a memory maintained at the ESMD. These read and write operations can thereby avoid overhead associated with copying data between different address spaces of memory separately maintained at respective computing platforms.

### BRIEF DESCRIPTION OF THE DRAWINGS

FIG. 1 illustrates an example first system.

FIG. 2 illustrates example controlled shared memory (COSM) management circuitry.

FIG. 3 illustrates an example second system.

FIG. 4 illustrates an example advance configuration and power interface (ACPI) configuration table.

FIG. 5 illustrates an example basic input/output operating system (BIOS) configuration table.

FIG. 6 illustrates an example registry table.

FIG. 7 illustrates an example process.

FIG. 8 illustrates an example code.

FIG. 9 illustrates an example logic flow.

FIG. 10 illustrates an example storage medium.

### DETAILED DESCRIPTION

Modern computing architectures typically attempt to have a seamless discovery and initialization of attached hardware devices such as, for example, an externally-attached shared memory device (ESMD). Traditional methods of hardware enumeration for attached hardware devices can rely on operating system (OS) level drivers and network-based discovery mechanisms, which can introduce latency, adds security vulnerabilities, and can cause potential incompatibilities in mission-critical environments. Current enumeration challenges include an OS-level detection dependency that depends on operating system drivers, which can introduce security risks. Enumeration challenges also include network-based discovery overhead via which some systems rely on network interfaces for device registration. This type of network-based discovery overhead can be slow and vulnerable to security breaches. Another enumeration challenge is lack of standardized firmware integration for externally-attached hardware devices like ESMDs with a host system's basic input/output OS (BIOS). Without a BIOS level integration an ESMD is likely to not be natively recognized by the host system's firmware.

In some examples, a low-level, secure, and efficient hardware device discovery and initialization that includes a BIOS-integrated auto-enumeration process that can leverage methods described in technical standards or specifications such as the Advanced Configuration and Power Interface (ACPI) specification, revision 6.6, originally published by the Unified Extensible Firmware Interface Forum (UEFI) in May 2025, herein referred to as “the ACPI specification. As described in this disclosure, example techniques that include auto-enumeration process that leverages methods described in the ACPI specification can ensure that an attached hardware devices such as an ESMD can be recognized/discovered and initialized before an OS is loaded by a host system's OS of a host attached to the ESMD. These example techniques can facilitate establishment of trusted execution environments, low-latency access to shared memory and/or accelerator resources maintained at the ESMD, and enable a seamless integration with system firmware and resource management layers.

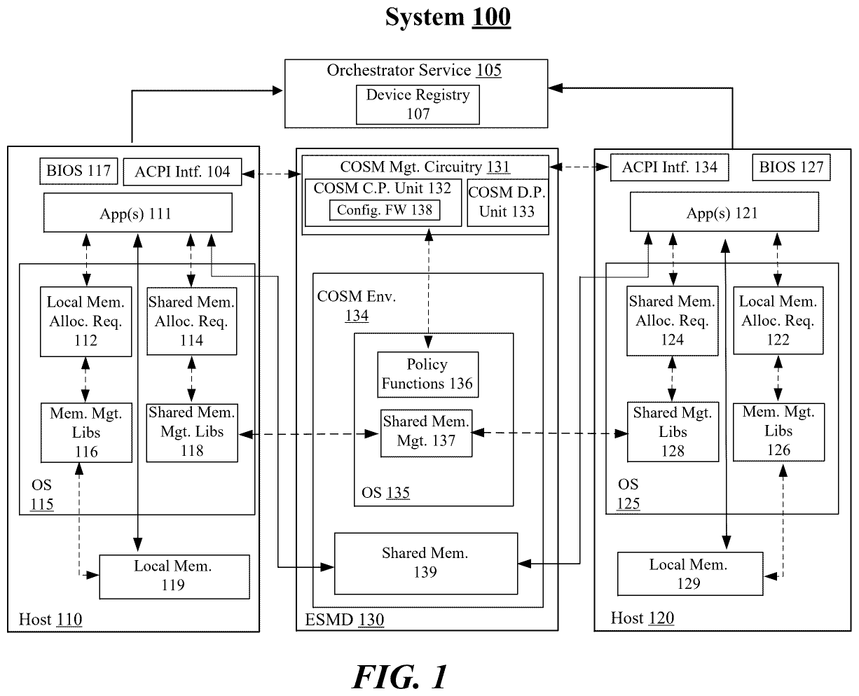

FIG. 1 illustrates an example system 100. According to some examples, as shown in FIG. 1, system 100 includes orchestrator service 105, a host 110 (e.g., host computing platform), a host 120 and an externally-attached shared memory device (ESMD) 130. Also as shown in FIG. 1, host 110 can be configured to include a BIOS 117, an ACPI interface (Intf.) 104, configured to host one or more applications (App(s)) 111, an operating system (OS) 115, and can maintain or include a local memory 119. Also, host 120 can be similarly configured to include a BIOS 127, an ACPI interface 134, configured to host one or more applications 121, an OS 125, and can maintain or include a local memory (mem.) 129.

According to some examples, as shown in FIG. 1, ESMD 130 includes controlled shared memory (COSM) management (mgt.) circuitry 131, an OS 135 and shared memory 139. Also as shown in FIG. 1, COSM management circuitry 131 can include a COSM control plane (C.P.) unit 132, a COSM data plane (D.P.) unit 133, and configuration firmware (Conf. FW) 138. As described in greater details below, configuration firmware 138 can facilitate a host's pre-OS enumeration of ESMD 130 to enable ESMD 130 to be available at boot-time and securely registered in a device registry 107 maintained with an Orchestrater service 105. Also, logic and/or features of COSM control plane unit 132 or COSM data plane unit 133 can be arranged or configured to set up and implement/enforce an isolation mechanism for access to one or more shared memory regions maintained in shared memory 139. A COSM environment (Env.) 134 can be established at ESMD 130 by COSM management circuitry 131 that can include OS 135 implementing policy functions 136 and shared memory (mem.) management (mgt.) 137 for access to one or more memory regions maintained in shared memory 139 based on the isolation mechanism that can include two levels. This two-level mechanism can include host-level access control as a first level and data-level inspection and enforcement as a second level. For example, respective application(s) 111, 121 can place a respective shared memory allocation request 114, 124 to respective OSs 115, 125 for use of and/or access to the one or more memory regions maintained in shared memory 139. OSs 115, 125 can be configured to coordinate with shared memory management 137 via establishment of respective shared memory (Mem.) management (Mgt.) libraries (Libs) 118, 128 to enable application(s) 111 or application(s) 121 to access one or more memory regions maintained in shared memory 139 based, at least in part, on policy or rules enforced by policy functions 136.

Local memories 119, 129 or shared memory 139 can include volatile and/or non-volatile types of memory. In some examples, local memories 119, 129 or shared memory 139 can include one or more dual in-line memory modules (DIMMs) that are arranged to include any combination of volatile or non-volatile memory. Volatile memory is memory whose state (and therefore the data stored on it) is indeterminate if power is interrupted to the device. Nonvolatile memory refers to memory whose state is determinate even if power is interrupted to the device. Dynamic volatile memory requires refreshing the data stored in the device to maintain state. One example of dynamic volatile memory includes DRAM (dynamic random-access memory), or some variant such as synchronous DRAM (SDRAM).

Although not shown in FIG. 1, host 110, host 120 or ESMD 130 may include additional components that facilitate inter-process communications and use of shared memory 139. For example, various network and/or internal communication interfaces and associated interconnects can communicatively couple the elements shown in FIG. 1 to each other or to elements on other hosts or ESMDs (not shown in FIG. 1).

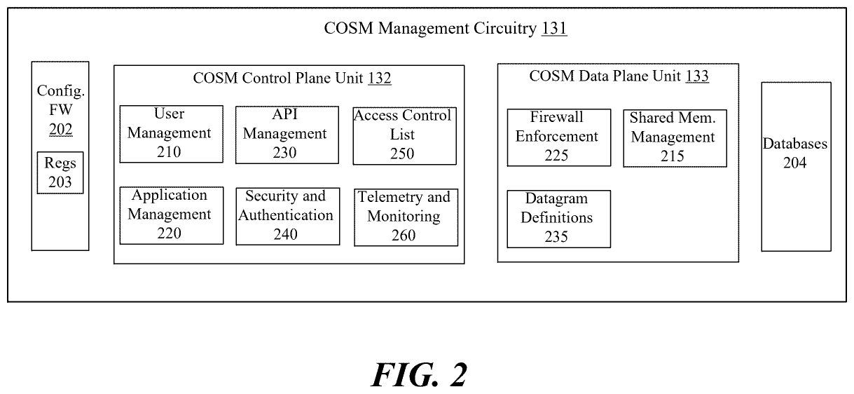

FIG. 2 illustrates example COSM management circuitry 131. In some examples, FIG. 2 shows example logical modules, configurations or databases that can be implemented by hardware circuitry, firmware, and/or software executed on an ESMD such as ESMD 130. For these examples, The COSM management circuitry 131 may include a COSM control plane unit 132, a COSM data plane unit 133 and configuration firmware (Config. FW) 138. As mentioned briefly above, configuration firmware 138 can facilitate a host's pre-OS enumeration of ESMD 130 to enable ESMD 130 to be available at boot-time and securely registered (e.g., in device registry 107). The COSM control plane unit 132 may be responsible for managing the configuration and establishment of memory-based communication channels in ESMD 130. With a memory-based communication channel configured, the COSM data plane unit 133 may manage operation of the memory-based communication channel following configuration, enforcing isolation policies and providing services to be used in the respective memory-based communication channels based on the configurations.

In some examples, as shown in FIG. 2, configuration firmware 138 can include or has access to one or more registers (Regs.) 203. For these examples, register 203 can include information to be used by configuration firmware 138 to interact with a host system's firmware during an enumeration process and provide device properties to the host system's firmware. The device properties, for example, can allow the host's BIOS (e.g., BIOS 117 of host 110) and ACPI interface (e.g., ACPI interface 104) to validate ESMD 130's security status and/or capabilities and then register ESMD 130 with a orchestrator service 105 (e.g., in device registry 107).

According to some examples, ESMD 130 can include two or more I/O ports to couple to devices representing different hosts or host domains. A domain can be defined as a set of system resources (e.g., hosts), to which certain users can have prescribed access rights as governed by security policies or service level agreements. Following a registration of ESMD with orchestrator service 105, COSM control plane unit 132 can interface with the attached devices to present ESMD 130 as an externally attached memory device (e.g., sharable memory device) accessible by the attached devices via their respective interconnect. For example, interconnects arranged to operate using peripheral component interface express (PCIe) protocols, compute express link (CXL) protocols, Ethernet protocols and/or other type of interconnect protocols. User management 210 can be arranged to identify a particular device, operating system, hypervisor, etc. of a host or host domain and determine attributes of the corresponding host and/or host domain, including policies and configurations to be applied for the host and/or host domain. User management 210 can further identify various applications (e.g., applications, services, processes, virtual machines, or threads) that can run on the host or host domain's OS or hypervisor and that may utilize communication channels implemented by ESMD 130. Application management 220 may identify, for the applications of each host and/or host domain, attributes, permissions, policies, and preferences for the applications so as to configure the manner in which individual applications can access and use memory-based communication channels (and their corresponding buffers or memory regions) implemented in ESMD 130. For instance, a single buffer/memory region or memory-based communication channel configured in ESMD 130 (e.g., maintained in shared memory 139) to enable communication between two or more host and/or host domain devices can be called upon, in some examples, to be used by multiple, distinct applications of a host and/or host domain, and application management 220 can configure the memory-based communication channel to establish isolation rules and policies that can govern how or if the applications share the memory-based communication channel, among other example configurations and considerations.

Continuing with the example of FIG. 2, API management 230 can be provided in some implementations to assist in configuring ESMD 130 and respective memory-based communication channels configured in ESMD 130 to interoperate in a system where ESMD 130 couples through an external switch or another ESMD to one or more host or host domains, with the memory-based communication channel being configured to consider the routing, protocols, and other attributes of the potential one-to-many coupling of ESMD 130 to potentially multiple distinct host or host domains through a single input/output (I/O) interface of ESMD 130, among other examples. Security and authentication 240 can be arranged to define and enforce security and authentication protocols (e.g., at the host, host domain or application level) for the memory-based communication channels, such that specific security features and/or policies are configured for the memory-based communication channels. Further, an access control list 250 can govern types of allowed or non-allowed accesses to ESMD 130. For example, enforcing access controls and permissions of the configuration port of an ESMD such as ESMD 130. Telemetry monitoring can also be managed for memory-based communication channels of specific hosts, host domains and/or applications. For instance, in accordance with QoS guarantees for various domains or applications. Telemetry monitoring access can be controlled using telemetry monitoring manager 260, among other example modules and logical blocks.

The COSM management circuitry 131 of an example ESMD such as ESMD 130 can additionally include COSM data plane unit 133 to govern the operation of various memory-based communication channels (and corresponding buffers or memory regions) configured in the shared memory maintained at ESMD 130 (e.g., shared memory 139) in accordance with configurations 202. Configurations 202, for example, can be set or implemented using COSM control plane unit 132. Individual buffers, memory regions and memory-based communication channels can have respective functionality, rules, protocols, and policies defined for the channel, and these channel or buffer definitions may be recorded within database 204. The COSM data plane unit 133 may include, for instance, shared memory management 215 to identify one or more portions of shared memory (e.g., buffers or memory regions) maintained at ESMD 130 to allocate for a specific memory-based communication channel and define pointers to provide to the host or host domain devices that are to communicate over the memory-based communication channel to enable the devices' access to the memory-based communication channel. Shared memory management 215 can leverage these pointers to effectively “turn off” or at least limit a device's or application's access and use of the memory-based communication channel by retiring the pointer, disabling the device's ability to write data on the buffer (to send data on the memory-based communication channel) or read data from a buffer (to receive/retrieve data on the memory-based communication channel), among other example functions. Other security and data filtering functions may be available for use in a memory-based communication channel, based on the configuration and/or policies applied to the memory-based communication channel, such as firewalling by firewall enforcement 225 (e.g., to enforce policies that limit certain data from being written to or read from a buffer or memory region) or data filtering (e.g., at the field level) associated with datagram definitions 235. Datagram definition 235 can be based on a data format of data written to or read from the memory-based communication channel (e.g., based on a protocol or other datagram format (including proprietary data formats) defined for the memory-based communication channel), to identify the presence of certain sensitive data to filter or redact such data and effectively protect such information from passing over the memory-based communication channel (e.g., from a more secure or higher trust domain to a less secure or lower trust domain), among other examples.

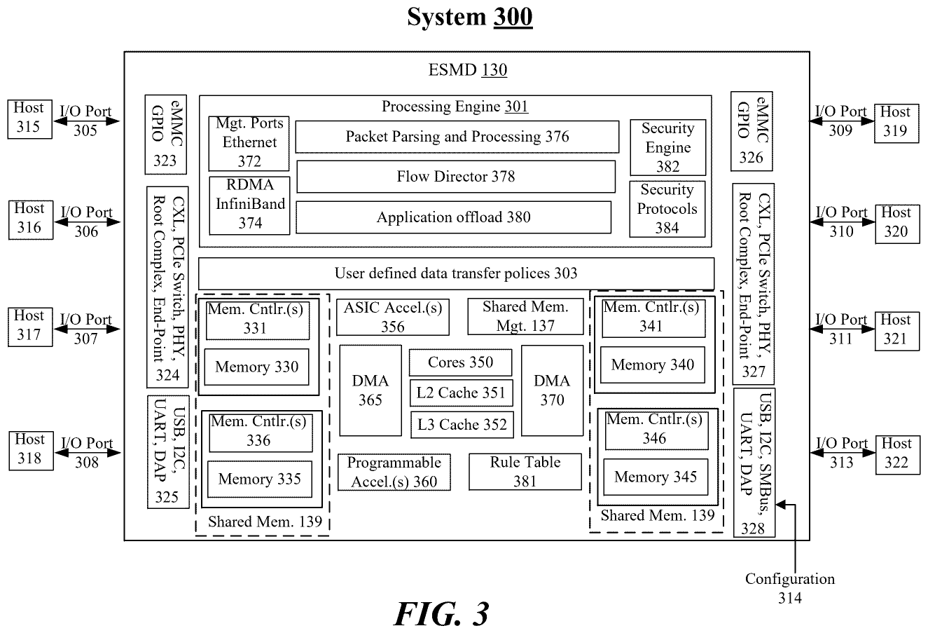

FIG. 3 illustrates an example system 300. According to some examples, as shown in FIG. 3, system 300 includes ESMD 130 coupled with a different set of hosts 313-322 through separate I/O ports 305-313. Hosts 315-322 can be associated with two or more different domains (e.g., domains of different ownership, trust levels, security features or permissions, etc.). Different interconnect protocols may be supported by the various I/O ports 305-313 of ESMD 130 (such as PCIe, CXL, Ethernet, ultra path interconnect (UPI), universal chiplet interconnect express (UCIe), NVLink, embedded multi-media controller (eMMC), general purpose I/O (GIPO), universal serial bus (USB), inter-integrated circuit (I2C), system management bus (SMBus), universal asynchronous receiver transmitter (UART), debug adaptor protocol (DA), etc.) and corresponding protocol logic (e.g., 323-324) may be provided on ESMD 130 to enable ESMD 130 to connect to, train, and communicate with the hosts 315-322 over corresponding links.

In some examples, one of the ports from among I/O ports 305-313 or an additional I/O port can be provided as a configuration channel 314, to enable a user or system to interface with ESMD 130 and configure functionality of the ESMD 130, define configurations for connections and communication with ESMD 130 (e.g., by hosts 315-322), define policies and rules that may be applied to memory-based communication channels implemented on ESMD 130, configure cross-domain and/or shared memory services provided by or through the hardware, firmware, and/or software executed on the ESMD 130, among other example features.

According to some examples, as mentioned briefly above for FIG. 1, ESMD 130 can also include shared memory 139. Shared memory 139 can include one or more memory elements (e.g., memory elements 330, 335, 340, 345), at least a portion of which can be offered as shared memory and implement buffers or memory regions through which two-level isolation schemes can be applied to implement memory-based communication channels between applications or processes hosted by two or more hosts (e.g., 315-323) or by a same host through an exchange of data over or through one or more shared buffers or memory regions. Portions of memory elements 330, 335, 340, 345 arranged to maintain memory regions or buffers designated for use as shared memory may be presented by ESMD 130 to hosts 315-322 as shared memory (e.g., using semantics of the corresponding interconnect protocol through which the host device connects to ESMD 130). Shared memory management 137 of ESMD 130 can be arranged to coordinate access to the shared memory by hosts 315-322 in cooperation with corresponding memory controllers 331, 336, 341, 346. That coordinated access can include performance of read or write memory operations on respective memory elements 330, 335, 340, 345. ESMD 130 can further include direct memory access (DMA) engines 365 or 370 to enable direct memory access (e.g., DMA reads and writes) by hosts 315-322) coupled to ESMD 130 and utilizing one or more memory regions or buffers of shared memory 139 for memory-based communication channels.

In some examples, one or more central processing unit (CPU) processor cores 350 can be provided on ESMD 130 to execute instructions and processes to implement the memory-based communication channel via use of one or more memory regions or buffers maintained in shared memory 139 in order to provide various cross domain services in connection with these one or more memory regions or buffers. The various cross domain service can be based on a respective configuration, isolation rules, and/or isolation policies defined for the one or more memory regions or buffers). The isolation rules and/or isolation policies can be maintained, for example, in rule table 381 at ESMD 130. A cache hierarchy that includes level-2 (L2) cache 351 and level-3 (L3) cache 352 can be provided, and cores 350 can be arranged to cooperate and interoperate with other processing/compute elements provided on the ESMD 130 such as one or more application specific integrated circuit (ASIC) accelerators (accel.(s)) 356 (e.g., cryptographic accelerators, error correction and detection accelerators, etc.) and various programmable hardware accelerators 360 (e.g., graphics accelerators (e.g., GPU), networking accelerators, machine learning accelerators, matrix arithmetic accelerators, field programmable gate array (FPGA)-based accelerators, etc.). Specialized processing functionality and acceleration capabilities (e.g., provided by ASIC accelerator(s) 356 or programmable accelerator(s) 360, etc.) can be leveraged to support memory-based communication channels provided through sharing one or more memory regions or buffers maintained in memory 139 of ESMD 130, based on configurations and rules defined for the memory-based communication channel (e.g., maintained in rule table 381).

According to some examples, logic and/or features can be provided on ESMD 130 to implement various cross domain services in connection with a memory-based communication channel established between hosts 315-322 via use of one or more memory regions or buffers maintained in shared memory 139. Such logic and/or features can be implemented in hardware circuitry (e.g., of accelerator devices (e.g., 356, 360), functional IP blocks, etc.), firmware or software (e.g., executed by cores 350). For these examples, functional cross domain service modules can thereby be implemented, such as modules that assist in emulating particular protocols, corresponding packet processing, and protocol features in a given memory-based communication channel (e.g., providing Ethernet-specific features (e.g., Dynamic Host Configuration Protocol (DHCP)), etc.) using an Ethernet port management module (e.g., 372), or remote DMA (RDMA) and InfiniBand features using an RDMA and/or InfiniBand module (e.g., 374). Various packet parsing and processing may be performed at ESMD 130 using, for example, packet parsing and processing 376, for instance, to parse packets written to a memory-based communication channel shared memory region or buffer and performing additional services on the packet to modify the packet or prepare the packet for reading by another host or device coupled to the memory-based communication channel shared memory region or buffer. Application management tasks may also be performed, including routing tasks (e.g., using a flow director 378) to influence the manner in which data communicated over a memory-based communication channel shared memory region or buffer is consumed and routed by the host or host domain receiving the data (e.g., specifying a process, core, virtual machine (VM), etc. at the host that should handle further processing of the data (e.g., based on packet inspection performed at ESMD 130), among other examples. Application offload 380 can be used to leverage information concerning a network connection of one of the hosts coupled to ESMD 130 to cause data read by the host to be forwarded in a particular manner on a network interface controller or other network element on the device (e.g., to further forward the data communicated over ESMD 130 supported memory-based communication channel to other hosts over the network). In other examples, ESMD 130 can perform various security services on data written and/or read from a memory-based communication channel shared memory region or buffer implemented on ESMD 130, for instance, applying custom or pre-defined security policies or tasks (e.g., using a security engine 382), applying particular security protocols to the communications carried over/through the memory-based communication channel shared memory region or buffer (e.g., IPSec using security protocols 384), among other example cross domain services and functionality.

According to some examples, a traditional internet protocol (IP) network can be at least partially replaced using one or more (or a network of) ESMDs. For these examples, ESMDs such as ESMD 130 can be utilized to implement cross-domain collaboration that allows information sharing to become more intent-centric. For instance, one or more applications executed in a first domain at a first host and the transactions required for communications with other applications of a different domain at the first host or a second host can be first verified for authenticity, security, or other attributes (e.g., based on an application's or domain's requirements), thereby enforcing implicit security. Memory-based communication can also offer a more reliable data transfer and simpler protocol operations for retransmissions and data tracking (e.g., than a more conventional data transfer over a network or interconnect link (which may be emulated by the memory-based communication). Through such simpler operations, ESMDs solutions can offer high-performance communication techniques between interconnecting domain-specific computing environments. Further, memory interfaces in an ESMD can be enforced with access controls and policies for secure operations, such as implementing a permission matrix scheme that can include a type of data-diode which cause memory-based communication channels to operate in a unidirectional fashion with permission-based access controls, such as write-only access, read-only access, and read/write access to access one or more memory-based communication channel shared memory regions or buffers. In other instances, a memory-based communication interface maintained by the ESMD can enable bi-directional communication between different hosts or different host domains. In some examples, separate memory regions or buffers can be used to facilitate each direction of communication (e.g., one memory region/buffer for communication from host A to host B and another memory region/buffer for communication from host B to host A). In such cases, different policies, cross domain services, and even protocols can be applied to each memory region/buffer, based on the disparate characteristics and requirements of the different hosts or host domains, among other example implementations. Generally, these memory-based communication interfaces can be a standard implementation and can also be open-sourced for easier use, community adoption, and public participation in technology contributions without compromising the security and isolation properties of the data transactions. The open implementation also provides transparency of communication procedures over open interfaces to identify any security vulnerabilities.

Traditional communication channels can utilize protocols, which define at least some constraints and costs in achieving compatibility between the connected hosts and applications that are to communicate over these traditional communication channels. An ESMD can enable support for application-defined communication protocols over open interface definitions (and open implementation), allowing customized communication solutions, which are wholly independent of or at least partially based on (and emulate) traditional interconnect protocols. For instance, application-defined communication protocols may enable applications to create their own datagram format, segmentation, encryption, and flow control mechanisms that are decoupled from the protocols used in the ESMD memory-based communication channel interfaces (connecting the ESMD to hosts).

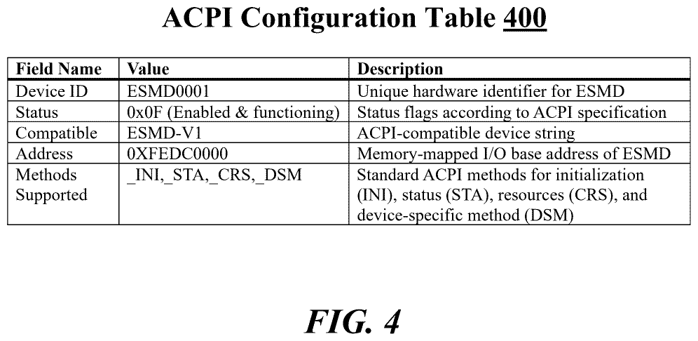

FIG. 4 illustrates an example ACPI configuration table 400. In some examples, an ACPI configuration table such as example ACPI configuration table 400 can include information to define how an ESMD can be exposed to a host's OS by the host's BIOS. For example, information included in ACPI configuration table 400 can be obtained from registers 203 of ESMD 130's configuration firmware 138. For this example, configuration table 400 can include information to ensure that at system startup, host 110 is able to recognizes ESMD 130 and its supported features via methods described in the ACPI specification. The information included in ACPI configuration table 400 can be necessary for OS 115 to interact with shared memory management 137 via shared memory management libraries 118 (e.g., cosm_libraries) and to securely manage shared memory included in shared memory 139. In other words, the information can be used by OS 115 to map or allocate one or more memory regions included in shared memory 139 to establish one or more memory-based communication channels with one or more other hosts that are coupled to ESMD 130. The fields included in ACPI configuration table 400 such as Device identifier (ID), Status (functioning status), Address (base address of shared memory region(s) of shared memory 139), and Methods Supported (ACPI methods) and associated value entries can allow ESMD 130 to integrate seamlessly with industry-standard system firmware interfaces.

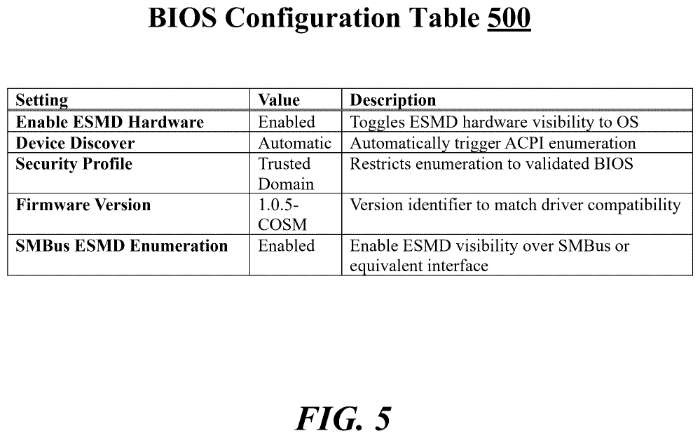

FIG. 5 illustrates an example BIOS configuration table 500. According to some examples, a BIOS configuration table such as example BIOS configuration table 500 can include information to describe how system firmware (BIOS) at a host can be configured to detect and support an ESMD. This information can be maintained at a host and can enable key functions like device discovery, security enforcement (e.g., trusted domain setup), and version tracking. For these examples, settings indicated in the Value column of BIOS configuration table 500 can control whether an ESMD such as ESMD 130 is visible to host OS (e.g., OS 115 or OS 125) and whether device discovery for the ESMD is initialized automatically. The information included in BIOS configuration table 500 can ensure that the correct firmware version and secure parameters are loaded during system boot. The information included in BIOS configuration table can also indicate whether ESMD 130 can be detected and enumerated over an I/O interface for system management such as, but not limited to, a system management bus (SMBus) I/O interface.

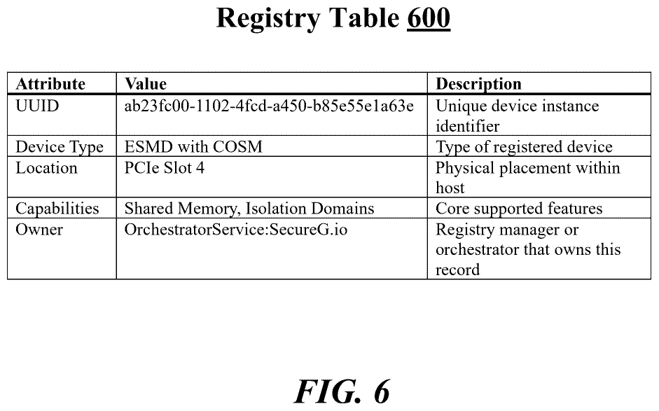

FIG. 6 illustrates an example registry table 600. According to some examples, a registry table such as example registry table 600 can include information to maintain a persistent record of each ESMD deployed in infrastructure (e.g., a data center or radio access network (RAN)) managed by an orchestrator service such as orchestrator service 105. A registry table for each ESMD can be maintained in a device registry (e.g., device registry 107) maintained at or by the orchestrator service. For example, a registry table such as registry table 600 can store metadata such as a universally unique identifier (UUIID), device type, physical location of ESMD, capabilities, and orchestrator service ownership. A registry table such as registry table 600 can be important for tracking deployed ESMDs, enforcing security policies, auditing, and enabling orchestration services to allocate and manage ESMD resources dynamically across distributed environments.

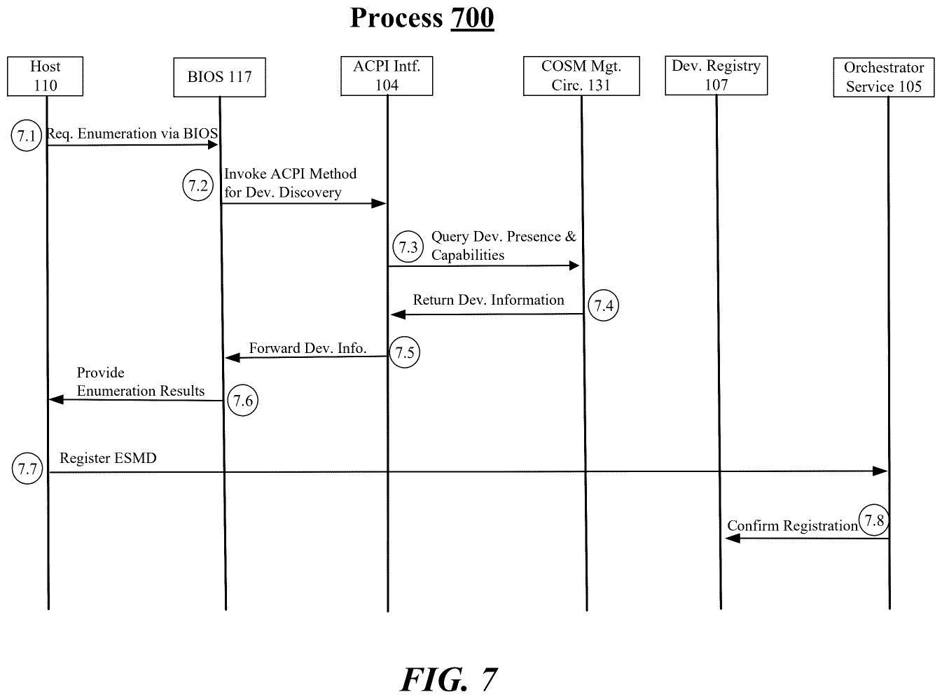

FIG. 7 illustrates an example process 700. According to some examples, portions of process 700 can be implemented by host 110, BIOS 117, ACPI interface (Intf.) 104, COSM management (Mgt.) circuitry (Circ.) 131, device registry 107, or orchestrator service 105 as mentioned above for FIGS. 1-6. Although examples are not limited to these elements for implementing process 700.

According to some examples, at 7.1, host 110 (e.g., host computing platform) begins start up with a firmware-based request for enumeration via BIOS being sent to BIOS 117. For these examples, BIOS configuration table 500 indicates that device discovery is enabled to cause an automatic trigger of enumeration at start up.

In some examples, at 7.2, BIOS 117 causes ACPI interface 104 to invoke ACPI method for device discovery. For these examples, ACPI configuration table 400 indicates the methods supported to include ACPI methods for initialization, status, resources, and device-specific operations.

According to some examples, at 7.3, as part of invoking ACPI method for device discovery, ACPI interface 104 causes a query of device presence and capabilities to be sent to COSM management circuitry 131.

In some examples, at 7.4, configuration firmware 138 of COSM management circuitry 131 can pull information from registers 203 and return device information to ACPI interface 104 that can indicate ESMD 130's capabilities.

According to some examples, at 7.5, ACPI interface 104 forwards the device information to BIOS 117. For these examples, the device information includes the information to populate the values maintained in a registry table (e.g., registry table 600) that can include a UUID, device type for ESMD 130, physical location, capabilities, or owner.

In some examples, at 7.6, BIOS 117 provides the enumeration results. For these examples, the enumeration results could indicate that ESMD 130 meets policy requirements and can be further configured for secure shared memory operations once host 110's OS boots up. The results can also include the device information that was forwarded to BIOS 117.

According to some examples, at 7.7, host 110 sends the device information to orchestrator service 105 to register ESMD 130 with orchestrator service 105. For these example, the device information can include the information included in registry table 600.

In some examples, at 7.8, orchestrator service 105 confirms registration with device registry 107. For these examples, the information included in registry table 600 is confirmed as being maintained device registry 107 and process 700 comes to an end.

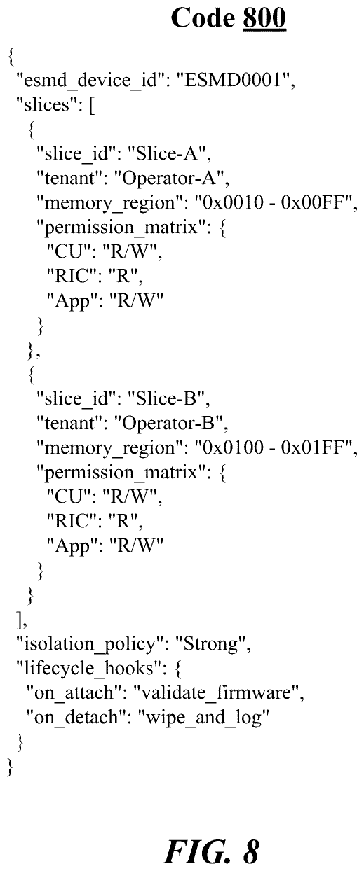

FIG. 8 illustrate an example code 800. In some examples, code 800 can represent a JavaScript Object Notation (JSON) like configuration that can define how an orchestrator such as orchestrator services 105 can provision and manage COSM-enabled isolation slices associated with shared memory regions maintain at one or more ESMDs such as ESMD 130. As shown in FIG. 8 for example code 800, individual isolation slices can have a unique identifier (ID), tenant association, memory region boundaries, and a permission matrix that indicates access privileges of different host or network functions that can access the individual isolation slices. The network functions, as shown in FIG. 8 for code 800 can include, but are not limited to, a central unit (CU), a RAN intelligent controller (RIC) or an application (App). A given permission matrix can indicate whether these network functions have read (R), write (W) or read/write (R/W) access to a shared memory region associated with a given isolation slice. Lifecyle hooks can be established to ensure that security policies are enforced during initialization and teardown of a COSM-enabled isolation slice. This type of structure for the orchestrator to provision and manage COSM-enable isolation slices can enable dynamic, policy-based resource isolation across clients, RAN slices, and edge applications.

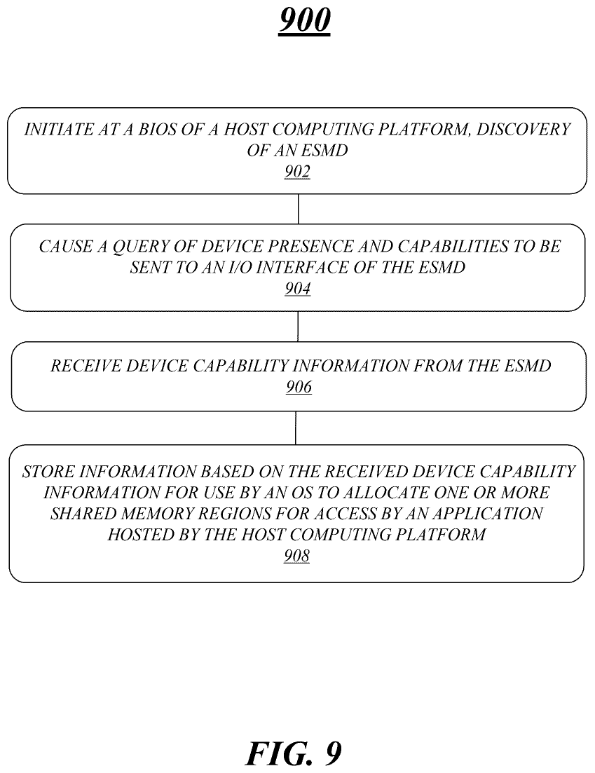

FIG. 9 illustrates an example logic flow 900. Logic flow 900 can be representative of some or all of the operations executed by one or more logic, features, or devices described herein, such as logic and/or features of at a host computing device such as host 110 that includes a BIOS and an ACPI interface such as BIOS 117 and ACPI interface 104 that interact with an ESMD such as ESMD 130 supported by COSM management circuitry 131.

In some examples, as shown in FIG. 9, logic flow 900 at block 902 can initiate, at a BIOS of a host computing platform, discovery of an ESMD. For these examples, BIOS 117 or host 110 can initiate discovery of ESMD 130 through interaction with ESMD 130's COSM management circuitry 131 that includes configuration firmware 138.

According to some examples, as shown in FIG. 9, logic flow 900 at block 904 can cause a query of device presence and capabilities to be sent to an I/O interface of the ESMD. For these examples, BIOS 117 can cause the query to be sent to ESMD 130 (e.g., through ACPI interface 104).

In some examples, as shown in FIG. 9, logic flow 900 at block 906 can receive device capability information from the ESMD. For these examples, ESMD 130 can send device capability information from one or more registers (e.g., registers 203) maintain at or by COSM management circuitry 131.

According to some examples, as shown in FIG. 9, logic flow 900 at block 908 can store information based on the received device capability information for use by an OS to allocate one or more shared memory regions for access by an application hosted by the host computing platform. For these examples, the stored information can be in a table populated by BIOS 117 to include similar information as shown in FIG. 4 for ACPI configuration table 400 to include, but not limited to, a device ID for ESMD 130, a functioning status of ESMD 130, a base address of a memory region included in the memory (e.g., base address of shared memory), or methods supported (e.g., ACPI methods supported).

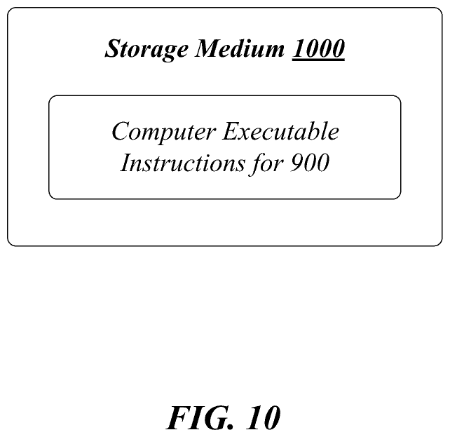

FIG. 10 illustrates an example of a storage medium. As shown in FIG. 10, the storage medium includes a storage medium 1000. The storage medium 1000 may comprise an article of manufacture. In some examples, storage medium 1000 can include any non-transitory computer readable medium or machine readable medium, such as an optical, magnetic or semiconductor storage. Storage medium 1000 can store various types of computer executable instructions, such as instructions to implement logic flow 900. Examples of a computer readable or machine readable storage medium can include any tangible media capable of storing electronic data, including volatile memory or non-volatile memory, removable or non-removable memory, erasable or non-erasable memory, writeable or re-writeable memory, and so forth. Examples of computer executable instructions can include any suitable type of code, such as source code, compiled code, interpreted code, executable code, static code, dynamic code, object-oriented code, visual code, and the like. The examples are not limited in this context.

One or more aspects of at least one example can be implemented by representative instructions stored on a machine-readable medium which represents various logic within the processor, which when read by a machine causes the machine to fabricate logic to perform the techniques described herein. Such representations, known as “IP cores” can be stored on a tangible, machine readable medium and supplied to various customers or manufacturing facilities to load into the fabrication machines that actually make the logic or processor.

Such machine-readable storage media may include, without limitation, non-transitory, tangible arrangements of articles manufactured or formed by a machine or device, including storage media such as hard disks, any other type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), phase change memory (PCM), magnetic or optical cards, or any other type of media suitable for storing electronic instructions.

Accordingly, various examples also include non-transitory, tangible machine-readable media containing instructions or containing design data, such as Hardware Description Language (HDL), which defines structures, circuits, apparatuses, processors and/or system features described herein. Such examples may also be referred to as program products.

In some cases, an instruction converter can be used to convert an instruction from a source instruction set to a target instruction set. For example, the instruction converter can translate (e.g., using static binary translation, dynamic binary translation including dynamic compilation), morph, emulate, or otherwise convert an instruction to one or more other instructions to be processed by the core. The instruction converter can be implemented in software, hardware, firmware, or a combination thereof. The instruction converter may be on processor, off processor, or part on and part off processor.

Various examples can be implemented using hardware elements, software elements, or a combination of both. In some examples, hardware elements can include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements can include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements can vary in accordance with any number of factors, such as desired computational rate, power levels, heat tolerances, processing cycle budget, input data rates, output data rates, memory resources, data bus speeds and other design or performance constraints, as desired for a given implementation.

Some examples may be described using the expression “in one example” or “an example” along with their derivatives. These terms mean that a particular feature, structure, or characteristic described in connection with the example is included in at least one example. The appearances of the phrase “in one example” in various places in the specification are not necessarily all referring to the same example.

Some examples may be described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, but yet still co-operate or interact with each other.

The following examples pertain to additional examples of technologies disclosed herein.

Example 1. An example apparatus can include an I/O interface, a memory arranged to include one or more memory regions shared with multiple host computing platforms externally attached to the apparatus, and circuitry. The circuitry can receive a query of device presence and device capabilities from a host computing platform via the I/O interface. The query can be initiated by a BIOS of the host computing platform based on the BIOS configured for automatic enumeration of a device upon startup of the host computing platform. The circuitry can also, responsive to the query, obtain device capability information from the one or more registers and send the device capabilities to the host computing platform.

Example 2. The apparatus of example 1 can also include the device capability information including a device ID, a functioning status of the apparatus, a base address of a memory region included in the memory, or discovery methods supported by the apparatus.

Example 3. The apparatus of example 2, the discovery methods can include ACPI methods in accordance with the ACPI specification for initialization, status, resources, or device-specific methods.

Example 4. The apparatus of example 1, the I/O interface can be an SMBus interface.

Example 5. An example method can include initiating, at a BIOS of a host computing platform, discovery of an ESMD. The method can also include causing a query of device presence and capabilities to be sent to an I/O interface of the ESMD. The method can also include receiving device capability information from the ESMD and storing information based on the received device capability information for use by an OS to allocate one or more shared memory regions for access by an application hosted by the host computing platform.

Example 6. The method of example 5 can also include generating registry information based on the received device capability information and sending the registry information to an orchestrator service.

Example 7. The method of example 5, the received device capability information can include a device ID, a functioning status of the ESMD, a base address of a memory region included in the memory, or discovery methods supported by the ESMD.

Example 8. The method of example 7, the discovery methods can include ACPI methods in accordance with the ACPI specification for initialization, status, resources, or device-specific methods.

Example 9. The method of example 5, the query of device presence and capabilities can be initiated by BIOS based on the BIOS configured for automatic enumeration of a device upon startup of the host computing platform.

Example 10. The method of example 6, causing the query of device presence and capabilities to be sent to the I/O interface of the ESMD can include the query to be sent to a SMBus interface of the ESMD.

Example 11. An example at least one machine readable medium can include a plurality of instructions that in response to being executed by a system at a host computing platform, causes the system to initiate, at a BIOS of the host computing platform, discovery of an ESMD. The instructions can also cause the system to cause a query of device presence and capabilities to be sent to an I/O interface of the ESMD. The instructions can also cause the system to receive device capability information from the ESMD and store information based on the received device capability information for use by an OS to allocate one or more shared memory regions for access by an application hosted by the host computing platform.

Example 12. The at least one machine readable medium of example 11, the instructions can further cause the system to generate registry information based on the received device capability information and send the registry information to an orchestrator service.

Example 13. The at least one machine readable medium of example 11, the received device capability information can include a device ID, a functioning status of the ESMD, a base address of a memory region included in the memory, or discovery methods supported by the ESMD.

Example 14. The at least one machine readable medium of example 13, the discovery methods can include ACPI methods in accordance with the ACPI specification for initialization, status, resources, or device-specific methods.

Example 15. The at least one machine readable medium of example 11, the query of device presence and capabilities can be initiated by BIOS based on the BIOS configured for automatic enumeration of a device upon startup of the host computing platform.

Example 16. The at least one machine readable medium of example 11, the instructions to cause the system to cause the query of device presence and capabilities to be sent to the I/O interface of the ESMD further includes the instruction to cause the system to cause the query to be sent to an SMBus interface of the ESMD.

It is emphasized that the Abstract of the Disclosure is provided to comply with 37 C.F.R. Section 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single example for the purpose of streamlining the disclosure. This method of disclosure is not to be interpreted as reflecting an intention that the claimed examples require more features than are expressly recited in each claim. Rather, as the following claims reflect, inventive subject matter lies in less than all features of a single disclosed example. Thus, the following claims are hereby incorporated into the Detailed Description, with each claim standing on its own as a separate example. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. An apparatus comprising:
an input/output (I/O) interface;
a memory arranged to include one or more memory regions shared with multiple host computing platforms externally attached to the apparatus; and
circuitry to:
receive a query of device presence and device capabilities from a host computing platform via the I/O interface, wherein the query is initiated by a basic input/output operating system (BIOS) of the host computing platform based on the BIOS configured for automatic enumeration of a device upon startup of the host computing platform; and
responsive to the query, obtain device capability information from the one or more registers and send the device capabilities to the host computing platform.

2. The apparatus of claim 1, wherein the device capability information includes a device identifier (ID), a functioning status of the apparatus, a base address of a memory region included in the memory, or discovery methods supported by the apparatus.

3. The apparatus of claim 2, wherein the discovery methods include Advanced Configuration and Power Interface (ACPI) methods in accordance with the ACPI specification for initialization, status, resources, or device-specific methods.

4. The apparatus of claim 1, wherein the I/O interface comprises a system management bus (SMBus) interface.

5. A method comprising:
initiating, at a basic input/output operating system (BIOS) of a host computing platform, discovery of an externally-attached shared memory device (ESMD);
causing a query of device presence and capabilities to be sent to an input/output (I/O) interface of the ESMD;
receiving device capability information from the ESMD; and
storing information based on the received device capability information for use by an operating system (OS) to allocate one or more shared memory regions for access by an application hosted by the host computing platform.

6. The method of claim 5, further comprising:
generating registry information based on the received device capability information; and
sending the registry information to an orchestrator service.

7. The method of claim 5, wherein the received device capability information includes a device identifier (ID), a functioning status of the ESMD, a base address of a memory region included in the memory, or discovery methods supported by the ESMD.

8. The method of claim 7, wherein the discovery methods include Advanced Configuration and Power Interface (ACPI) methods in accordance with the ACPI specification for initialization, status, resources, or device-specific methods.

9. The method of claim 5, wherein the query of device presence and capabilities is initiated by BIOS based on the BIOS configured for automatic enumeration of a device upon startup of the host computing platform.

10. The method of claim 6, wherein causing the query of device presence and capabilities to be sent to the I/O interface of the ESMD comprises the query to be sent to a system management bus (SMBus) interface of the ESMD.

11. At least one machine readable medium comprising a plurality of instructions that in response to being executed by a system at a host computing platform, causes the system to:
initiate, at a basic input/output operating system (BIOS) of the host computing platform, discovery of an externally-attached shared memory device (ESMD);
cause a query of device presence and capabilities to be sent to an input/output (I/O) interface of the ESMD;
receive device capability information from the ESMD; and
store information based on the received device capability information for use by an operating system (OS) to allocate one or more shared memory regions for access by an application hosted by the host computing platform.

12. The at least one machine readable medium of claim 11, the instructions to further cause the system to:
generate registry information based on the received device capability information; and
send the registry information to an orchestrator service.

13. The at least one machine readable medium of claim 11, wherein the received device capability information includes a device identifier (ID), a functioning status of the ESMD, a base address of a memory region included in the memory, or discovery methods supported by the ESMD.

14. The at least one machine readable medium of claim 13, wherein the discovery methods include Advanced Configuration and Power Interface (ACPI) methods in accordance with the ACPI specification for initialization, status, resources, or device-specific methods.

15. The at least one machine readable medium of claim 11, wherein the query of device presence and capabilities is initiated by BIOS based on the BIOS configured for automatic enumeration of a device upon startup of the host computing platform.

16. The at least one machine readable medium of claim 11, wherein to cause the query of device presence and capabilities to be sent to the I/O interface of the ESMD comprises to cause the query to be sent to a system management bus (SMBus) interface of the ESMD.
